(19) United States
(12) Patent Application Publication
(10) Pub. No.: US 2021/0266840 A1
(43) Pub. Date: Aug. 26, 2021

(54) METHOD FOR CELL MEASUREMENT, UE, AND BASE STATION

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventors: Xiaodong XU, Beijing (CN); Na LI, Beijing (CN)

(73) Assignees: CHINA MOBILE COMMUNICATION CO., LTD RESEARCH INSTITUTE, Beijing (CN); CHINA MOBILE COMMUNICATIONS GROUP CO., LTD., Beijing (CN)

(21) Appl. No.: 17/261,010

(22) PCT Filed: Jul. 18, 2019
(86) PCT No.: PCT/CN2019/096608

§ 371 Date: Jan. 16, 2021

(30) Foreign Application Priority Data
Jul. 18, 2018 (CN) 201810801336.6

(51) Int. Cl. H04W 52/02; H04W 68/00; H04W 24/10; H04W 60/04

(52) U.S. Cl. CPC H04W 52/0235; H04W 60/04; H04W 24/10; H04W 68/005

(57) ABSTRACT

A method for cell measurement includes: User Equipment (UE) acquires paging configuration information, the paging configuration information including at least a paging cycle for a neighbor cell; and the UE performs measurement on a serving cell and the neighbor cell based on the paging configuration information. Another method for cell measurement is also provided, which includes that: a base station sends paging configuration information to a UE, the paging configuration information including at least a paging cycle for a neighbor cell.

### CROSS-REFERENCE TO RELATED APPLICATIONS

This application is based on, and claims priority to Chinese Patent Application No. 201810801336.6 filed on Jul. 18, 2018, the disclosure of which is hereby incorporated by reference in its entirety.

### TECHNICAL FIELD

The present disclosure relates to information processing in the field of mobile communications, and more particularly, to a method for lowering power consumption of User Equipment (UE), a UE, a base station, and a computer storage medium.

### BACKGROUND

In Long Term Evolution (LTE), different cells may be configured with different paging cycles and paging density (nB). UEs in a same cell perform paging monitoring and idle state measurement based on configuration parameters of the cell. This leads to a problem that power saving performance achieved by UEs in different cells is different, and power saving needs of UEs in the same cell will be limited by unified configuration parameters of the cell. As illustrated in FIG. 1, a paging cycle of a serving cell of UE is 640 ms. A paging cycle of a neighbor cell 1 is 1280 ms. A paging cycle of a neighbor cell 2 is 2560 ms. With the related art, the UE has to monitor a paging message and perform measurement at a cycle of 640 ms even if the UE is a UE with a power saving need. However, UEs with power saving needs in neighbor cell 1 and neighbor cell 2 may monitor paging messages and perform measurements using longer cycles (1280 ms and 2560 ms, respectively). It may be seen that power-saving performance of the UE is limited by current configuration for a parameter related to paging in the serving cell.

### SUMMARY

The present disclosure mainly serves to propose a method for lowering power consumption of User Equipment (UE), a UE, a base station, and a computer storage medium.

The present disclosure provides a method for lowering power consumption of User Equipment (UE), applied to UE. The method includes:

acquiring paging configuration information, where the paging configuration information includes at least a paging cycle for a neighbor cell; and

performing measurement on a serving cell and the neighbor cell based on the paging configuration information.

The present disclosure provides a method for lowering power consumption of User Equipment (UE), applied to a base station. The method includes: sending paging configuration information to UE.

The paging configuration information includes at least a paging cycle for a neighbor cell.

The present disclosure provides User Equipment (UE), including an information receiving unit and a measuring unit.

The information receiving unit is configured for acquiring paging configuration information, where the paging configuration information includes at least a paging cycle for a neighbor cell.

The measuring unit is configured for performing measurement on a serving cell and the neighbor cell based on the paging configuration information.

The present disclosure provides User Equipment (UE), including a first communication interface and a first processor.

The first communication interface is configured for acquiring paging configuration information, where the paging configuration information includes at least a paging cycle for a neighbor cell.

The first processor is configured for performing measurement on a serving cell and the neighbor cell based on the paging configuration information.

The present disclosure provides a base station, including an information sending unit configured for: sending paging configuration information to UE.

The paging configuration information includes at least a paging cycle for a neighbor cell.

The present disclosure provides a base station, including a second communication interface configured for: sending paging configuration information to UE.

The paging configuration information includes at least a paging cycle for a neighbor cell.

The present disclosure provides User Equipment (UE), including a processor and memory configured for storing a computer program executable by the processor.

The processor is configured for performing steps of the method when executing the computer program.

The present disclosure provides a base station, including a processor and memory configured for storing a computer program executable by the processor.

The processor is configured for performing steps of the method when executing the computer program.

The present disclosure provides a computer storage medium, having stored thereon a computer program which, when executed by a processor, causes the processor to perform steps of the method.

With a solution provided herein, it is possible to perform measurement on the serving cell of the UE or a neighbor cell of the UE according to the paging configuration information issued by the network side, thereby implementing measurement based on the paging cycle of the neighbor cell, instead of the paging cycle of the serving cell according to related art, thereby reducing unnecessary measurement on the neighbor cell, and reducing power consumption of the UE.

### BRIEF DESCRIPTION OF THE ACCOMPANYING DRAWINGS

FIG. 1 is a diagram of a scene of a paging opportunity and a paging cycle.

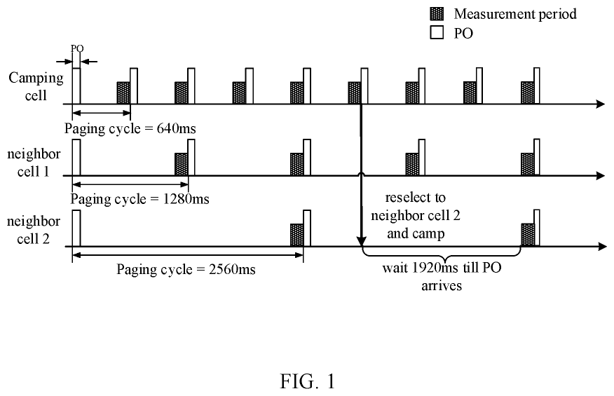

FIG. 2 is a first flowchart of a method for lowering power consumption of User Equipment (UE) according to an embodiment of the present disclosure.

FIG. 3 is a second flowchart of a method for lowering power consumption of User Equipment (UE) according to an embodiment of the present disclosure.

FIG. 4 is a third flowchart of a method for lowering power consumption of User Equipment (UE) according to an embodiment of the present disclosure.

FIG. 5 is a fourth flowchart of a method for lowering power consumption of User Equipment (UE) according to an embodiment of the present disclosure.

FIG. 6 is a fifth flowchart of a method for lowering power consumption of User Equipment (UE) according to an embodiment of the present disclosure.

FIG. 7 is a sixth flowchart of a method for lowering power consumption of User Equipment (UE) according to an embodiment of the present disclosure.

FIG. 8 is a diagram of a structure of UE according to an embodiment of the present disclosure.

FIG. 9 is a diagram of another structure of UE according to an embodiment of the present disclosure.

FIG. 10 is a diagram of a structure of a base station according to an embodiment of the present disclosure.

### DETAILED DESCRIPTION

To understand a feature and technical content of embodiments herein in more details, implementation of embodiments herein is elaborated below with reference to the accompanying drawings. The accompanying drawings are for reference only and are not intended to limit embodiments herein.

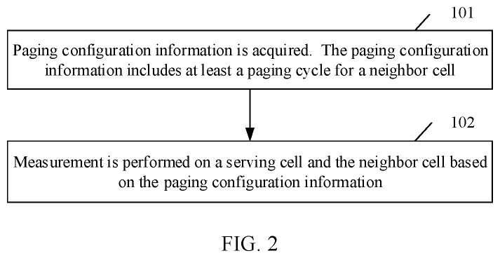

Embodiments herein provide a method for lowering power consumption of User Equipment (UE), applied to UE. As shown in FIG. 2, the method includes steps as follows.

In S101, paging configuration information is acquired. The paging configuration information includes at least a paging cycle for a neighbor cell.

In S102, measurement is performed on a serving cell and the neighbor cell based on the paging configuration information.

In an embodiment herein, the operation of acquiring paging configuration information may include that: paging configuration information for a neighbor cell of the serving cell of the UE is acquired. The paging configuration information includes at least a paging cycle, and may also include a paging density nB. Specifically, the paging configuration information may include a paging density for a neighbor cell. Of course, understandably, the paging configuration information may also include the paging density of the serving cell, and in addition, may also include other information, but it is not exhaustively listed in this embodiment.

Refer to specific description as follows for a paging cycle and a paging density.

A paging cycle may be a paging cycle by default.

A paging cycle, i.e., a Discontinuous Reception (DRX) cycle, may take on a value of 32, 64, 128, or 256 radio frames. The UE has to wake up once during each DRX Cycle, and try to receive a Paging message. Therefore, the greater the value is, the lower the power consumption of the UE in the IDLE state, however the greater the average delay of the paging message on a radio channel.

An nB may take on a value of 4T, 2T, T, T/2, T/4, T/8, T/16, and T/32. The T stands for a DRX cycle. The parameter mainly represents the density of paging. For example, 4T means that 4 sub-frames per each radio frame are used for paging.

The UE may compute a paging opportunity (PO) and a paging frame (PF) per se according to the information received in SIB2. Alternatively, a PO may be understood as the location of a paging sub-frame, computed as follows.

A DRX cycle ultimately used by the UE is acquired as T=min(Tc, Tue) based on the cell-specific DRX cycle Tc (i.e. defaultPagingCycle) in SIB2, and the UE-specific DRX cycle Tue, configured by Mobility Management Entity (MME) through IE: Paging DRX.

A number of PFs included in each DRX cycle is computed as N=min(T, nB).

A number of POs in each PF is computed as Ns=max(1, nB/T).

UE_ID=IMSI mod 1024.

A PF is a system frame that satisfies: SFN mod T=(T div N)*(UE_ID mod N).

The two tables as follows are searched using an index i_s=floor(UE_ID/N) mod Ns, to obtain a PO (see TS36.304).

In the case of FDD, the PO may be any of sub-frames 0, 4, 5, and 9.

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

In the case of TDD, the PO may be any of sub-frames 0, 1, 5, and 6.

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

For example,

| | TDD cell 1 (serving cell) | TDD cell 2 (neighbor cell) |
|---|---|---|
| IMSI | 404685505601234 | |
| UE_ID | IMSI mod 1024 = 722 | |
| Tue | 128 | |
| Tc | 32 | 256 |
| T | T = min(Tc, Tue) = 32 | T = min(Tc, Tue) = 128 |
| nB | 4T | T/2 |
| N | N = min(T, nB) = 32 | N = min(T, nB) = 64 |
| Ns | Ns = max(1, nB/T) = 4 | Ns = max(1, nB/T) = 1 |
| i_s | i_s = floor(UE_ID/N) | i_s = floor(UE_ID/N) |
| | mod Ns = 2 | mod Ns = 0 |
| PF | It is computed that PF | SFN mod T = (T div N)*(UE_ID |
| | has to meet: | mod N) is met |
| | SFN mod 32 = 18 | It is computed that PF has to meet: |
| | | SFN mod 128 = 36 |
| PO | By looking up the table | By looking up the table using Ns |
| | using Ns and i_s, the | and i_s, the sub-frame |
| | sub-frame number is 5 | number is 0 |

If a paging message is monitored according to a neighbor cell, the UE only needs to wake up once every 128 radio frames. Power consumption may be lowered by 75%.

In this case, the UE may be made to perform measurement on the TDD cell 2 (neighbor cell) using a default paging cycle and a default paging density, to minimize UE power consumption caused by TDD cell 2 (neighbor cell) measurement. Alternatively, the default paging cycle is maintained, increasing the paging density, etc., properly, to achieve a balance between a measurement performance and a UE power consumption.

The paging configuration information is paging configuration information received by the base station managing the serving cell from a base station managing the neighbor cell through an interface between the base station managing the serving cell and the base station managing the neighbor cell.

Alternatively, the paging configuration information is paging configuration information for the neighbor cell received by the base station managing the serving cell from a core network through an S1 interface or a Non-Guaranteed (NG) interface between the base station managing the serving cell and the core network.

That is to say, before step 101 is performed, base stations at the network side will interact with each other. Specifically, the method may also include one of two steps as follows.

A neighbor base station sends paging configuration information for a neighbor cell to the base station managing the serving cell of the UE through an interface between the base stations.

Before this step, the method may further include that the neighbor base station receives a paging configuration request message. That is, the base station managing the serving cell requests the neighbor base station for a paging configuration for the neighbor cell.

The base station managing the serving cell may select multiple neighbor cells based on a result of measurement by the UE, and send paging configuration request messages to neighbor base stations managing these neighbor cells.

In addition, a logic network element of a core network sends paging configuration information for a neighbor cell to the base station managing the serving cell through an S1/NG interface.

Before this step, the method may further include that the logic network element of the core network receives a paging configuration report message. That is, all base stations belonging to a logic network element of the core network report cell paging configurations to the logic network element of the core network.

The granularity for the logic network element of the core network to issue a paging configuration may be TA (tracking area). That is, base stations belonging to the same TA area all issue the same cell paging configuration.

The logic network element of the core network may be an MME or an Access and Mobility Management Function (AMF).

If a neighbor cell and the serving cell belong to the same base station, the above steps are not required.

The base station managing the serving cell may send a paging configuration with a granularity of a TA (tracking area) or a Radio Access Network (RAN) area. A paging configuration with a TA granularity is sent by an MME/AMF to the base station managing the UE serving cell through an S1/NG interface. A paging configuration with a RAN area granularity is determined by the base station managing the UE serving cell.

UE may obtain a paging configuration for a neighbor cell by acquiring the paging configuration information, by:

receiving Radio Resource Control (RRC) dedicated signaling or a system message of a base station managing the serving cell; and

extracting the paging configuration information from the system message or the RRC dedicated signaling.

System information of the serving cell, such as multiplexed SIB2, or RRC dedicated signaling, such as an RRC connection release message or an RRC connection establishment message, is received.

Idle-state UE receives system information from the serving cell. Connected-state UE receives system information or RRC dedicated signaling from the serving cell.

The following describes how UE performs measurement based on paging configurations of the serving cell and a neighbor cell.

Measurement may be performed based on paging configuration for a cell/cells, which may be determined in one of two modes as follows.

Measurement may be performed on the serving cell and the neighbor cell in a network-assisted mode based on the paging configuration information.

Alternatively, measurement may be performed on the serving cell and the neighbor cell in a network-controlled mode based on the paging configuration information.

In the network-assisted mode, paging configuration information of all neighbor cells of the UE are acquired. That is, the UE obtains the paging configuration information of all neighbor cells from the base station. The UE decides which paging configuration or paging configurations on which measurement is based, and how to perform measurement. Specifically, it may be one of the following three processing manners:

In a first processing manner, a paging cycle and/or a paging density in paging configuration information for a target neighbor cell is selected based on a paging cycle and/or a paging density for the serving cell, paging configuration information for the neighbor cell in the paging configuration information, and a power saving need and/or a measurement need of the UE, and the serving cell and the neighbor cell are measured based on the selected paging cycle and/or paging density in the paging configuration information for the target neighbor cell.

UE decides which cell's paging configuration to use based on a power saving need and/or a measurement need of the UE. For example, the UE needs to save as much power as possible. Then, the UE performs measurement on the serving cell and any neighbor cell according to a paging configuration among paging configurations for the serving cell and neighbor cells with the greatest paging cycle. As another example, the UE selects a compromised paging cycle from paging configurations for all cells to measure the serving cell and neighbor cells.

A power saving need may mean that UE has ever reported to the network when it was in a connected state and wanted to modify a DRX cycle to a larger value. Thereby, the network may infer that the UE may need to save power during this period. So, when the UE enters into the idle state, a UE-specific paging cycle, which is larger than the defaultPagingCycle, may be configured for the UE.

A measurement need may mean that UE has ever reported some auxiliary information, such as location information reported by the UE within a period of time. Based on the location information, the network finds that the UE is in a certain area during this period, and it is predicted that the UE will remain in the area for a long time in the future. In a scene, the user stays in an office building all day. In this case, the network deems that the UE does not need to measure so frequently, because the UE hardly triggers any mobility-related operation. Therefore, the network will configure a UE-specific paging cycle larger than the defaultPagingCycle for the UE.

In a second processing manner, measurement is performed on the serving cell based on a paging cycle and/or a paging density in paging configuration information for the serving cell. Measurement is performed on each neighbor cell based on a paging cycle and/or a paging density in paging configuration information for the each neighbor cell.

That is, the UE performs measurement on the serving cell using the paging configuration for the serving cell, and performs measurement on a neighbor cell using the paging configuration for the neighbor cell.

In a third processing manner, measurement is performed on the serving cell based on paging configuration information for the serving cell.

At least one piece of paging configuration information in paging configuration information for all neighbor cells is selected. Measurement is performed on a neighbor cell based on a paging cycle and/or a paging density in the at least one piece of paging configuration information as selected.

That is, the UE performs measurement on the serving cell using the paging configuration for the serving cell, and selects one or more paging cycles from the paging configurations of all neighbor cells to measure a neighbor cell.

In the network-controlled mode, UE has to perform idle-state measurement according to a cell paging configuration sent by the base station. Specifically, measurement is performed on the serving cell and the neighbor cell in the network-controlled mode based on the paging configuration information in one of the following processing manners.

In a first processing manner, a power saving need and/or a measurement need may be sent to a base station. Paging configuration information to be used sent by the base station may be received. Measurement may be performed on the serving cell and the neighbor cell based on the paging configuration information to be used.

For example, the base station determines which cell's paging configuration the UE is to use based on a power saving need and/or a measurement need previously reported by the UE. In this case, the UE is to perform measurement on the serving cell and a neighbor cell based on the paging configuration indicated by the base station.

In a second processing manner, paging configuration information is acquired as follows.

Paging configuration information for each cell on which measurement is to be performed is acquired from the base station. A cell on which measurement is to be performed includes a serving cell and a neighbor cell.

Correspondingly, measurement may be performed on the serving cell and the neighbor cell based on paging configuration information for the serving cell and the neighbor cell sent by a base station.

For example, the base station has sent a respective paging configuration for each cell. Then, the UE must perform measurement on the serving cell and a neighbor cell based on respective paging configurations corresponding respectively to the serving cell and the neighbor cell.

In a third processing manner, paging configuration information may be acquired as follows.

At least one piece of paging configuration information sent by the base station for the serving cell and the neighbor cell may be acquired.

Correspondingly, measurement may be performed on the serving cell and the neighbor cell based on at least one piece of paging configuration information sent by a base station.

In other words, the base station sends one or more paging configurations for the serving cell and neighbor cells. The UE performs measurement on the serving cell and a neighbor cell based on the one or more paging configurations.

In a fourth processing manner, paging configuration information may be acquired as follows.

Paging configuration information for the serving cell and at least one piece of paging configuration information sent for neighbor cells may be acquired from the base station.

Correspondingly, measurement may be performed on the serving cell based on paging configuration information for the serving cell. Measurement may be performed on a neighbor cell based on at least one piece of paging configuration information corresponding to the neighbor cell sent by a base station.

In other words, the base station sends a paging configuration for the serving cell, and sends another paging configuration or other paging configurations for all neighbor cells. Then, the UE has to perform measurement on the serving cell based on the paging configuration for the serving cell, and perform measurement on all neighbor cells based on the one or more paging configurations for the neighbor cells.

In a fifth processing manner, paging configuration information may be acquired as follows.

A cell group-based paging configuration information may be acquired.

Correspondingly, in performing measurement on the serving cell or a neighbor cell, measurement may be performed on paging configuration information corresponding to a cell group including the serving cell or the neighbor cell based on paging configuration information for the cell group corresponding to the serving cell and the neighbor cell.

That is, the base station sends a cell group-based paging configuration for the serving cell and neighbor cells. The UE has to perform measurement on a cell based on paging configuration for the cell group including the cell. A cell group may be formed based on a cell frequency or another configuration (such as a paging area, a tracking area).

In a sixth processing manner, paging configuration information may be acquired as follows.

First paging configuration information sent by the base station for the serving cell may be acquired. Cell group-based second paging configuration information sent by the base station for the neighbor cell may be acquired.

Correspondingly, measurement may be performed on the serving cell based on first paging configuration information for the serving cell. Measurement may be performed on a neighbor cell based on second paging configuration corresponding to a cell group including the neighbor cell.

There may be multiple pieces of second paging configuration information, and the number is not limited here.

In other words, the base station sends a paging configuration for the serving cell and a cell group-based paging configuration for a neighbor cell. The UE has to perform measurement on the serving cell based on the paging configuration for the serving cell. The UE has to perform measurement on a neighbor cell based on the paging configuration for the cell group to which the neighbor cell belongs.

Embodiments herein further provide a method for lowering power consumption of User Equipment (UE), applied to a base station, which includes that: paging configuration information is sent to UE. The paging configuration information includes at least a paging cycle for a neighbor cell.

In an embodiment herein, paging configuration information is acquired may include that paging configuration information for a neighbor cell of the serving cell of the UE is acquired. The paging configuration information includes at least a paging cycle, and may also include a paging density nB. Specifically, the paging configuration information may include a paging density for a neighbor cell. Of course, understandably, the paging configuration information may also include the paging density of the serving cell, and in addition, may also include other information, but it is not exhaustively listed in this embodiment.

Refer to specific description as follows for a paging cycle and a paging density.

A paging cycle may be a paging cycle by default.

A paging cycle, i.e., a DRX cycle, may take on a value of 32, 64, 128, or 256 radio frames. The UE has to wake up once during each DRX Cycle, and try to receive a Paging message. Therefore, the greater the value is, the lower the power consumption of the UE in the IDLE state, however the greater the average delay of the paging message on a radio channel.

An nB may take on a value of 4T, 2T, T, T/2, T/4, T/8, T/16, and T/32. The T stands for a DRX cycle. The parameter mainly represents the density of paging. For example, 4T means that 4 sub-frames per each radio frame are used for paging.

The UE may compute a paging opportunity (PO) and a paging frame (PF) per se according to the information received in SIB2. Alternatively, a PO may be understood as the location of a paging sub-frame, computed as follows.

A DRX cycle ultimately used by the UE is acquired as T=min(Tc, Tue) based on the cell-specific DRX cycle Tc (i.e. defaultPagingCycle) in SIB2, and the UE-specific DRX cycle Tue, configured by Mobility Management Entity (MME) through IE: Paging DRX.

A number of PFs included in each DRX cycle is computed as N=min(T, nB).

A number of POs in each PF is computed as Ns=max(1, nB/T).

UE_ID=IMSI mod 1024.

A PF is a system frame that satisfies: SFN mod T=(T div N)*(UE_ID mod N).

The two tables as follows are searched using an index i_s=floor(UE_ID/N) mod Ns, to obtain a PO (see TS36.304).

In the case of FDD, the PO may be any of sub-frames 0, 4, 5, and 9.

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

In the case of TDD, the PO may be any of sub-frames 0, 1, 5, and 6.

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

For example,

| | TDD cell 1 (serving cell) | TDD cell 2 (neighbor cell) |
|---|---|---|
| IMSI | 404685505601234 | |
| UE_ID | IMSI mod 1024 = 722 | |
| Tue | 128 | |
| Tc | 32 | 256 |
| T | T = min(Tc, Tue) = 32 | T = min(Tc, Tue) = 128 |
| nB | 4T | T/2 |
| N | N = min(T, nB) = 32 | N = min(T, nB) = 64 |
| Ns | Ns = max(1, nB/T) = 4 | Ns = max(1, nB/T) = 1 |
| i_s | i_s = floor(UE_ID/N) | i_s = floor(UE_ID/N) mod |
| | mod Ns = 2 | Ns = 0 |
| PF | It is computed that PF | SFN mod T = (T div N)*(UE_ID |
| | has to meet: | mod N) is met |
| | SFN mod 32 = 18 | It is computed that PF has to meet: |
| | | SFN mod 128 = 36 |
| PO | By looking up the table | By looking up the table using Ns |
| | using Ns and i_s, the | and i_s, the sub-frame |
| | sub-frame number is 5 | number is 0 |

If a paging message is monitored according to configuration for the serving cell, the UE only needs to wake up once every 32 radio frames. However, if a paging message is monitored according to a neighbor cell, the UE only needs to wake up once every 128 radio frames. Power consumption may be lowered by 75%.

In this case, the UE may be made to perform measurement on the TDD cell 2 (neighbor cell) using a default paging cycle and a default paging density, to minimize UE power consumption caused by TDD cell 2 (neighbor cell) measurement. Alternatively, the default paging cycle is maintained, increasing the paging density, etc., properly, to achieve a balance between a measurement performance and a UE power consumption.

The method may further include: before sending the paging configuration information to the UE, sending a paging configuration request message to a base station managing the neighbor cell through an interface with the base station managing the neighbor cell, and receiving paging configuration information sent by the base station managing the neighbor cell through the interface with the base station managing the neighbor cell.

That is to say, a neighbor base station sends paging configuration information for a neighbor cell to the base station managing the serving cell of the UE through an interface between the base stations.

Before this step, the method may further include that the neighbor base station receives a paging configuration request message. That is, the base station managing the serving cell requests the neighbor base station for a paging configuration for the neighbor cell.

The base station managing the serving cell may select multiple neighbor cells based on a result of measurement by the UE, and send paging configuration request messages to neighbor base stations managing these neighbor cells.

A logic network element of a core network sends paging configuration information for a neighbor cell to the base station managing the serving cell through an S1/NG interface.

The method may further include, before the step, sending paging configuration information of the base station to a core network. That is, all base stations belonging to a logic network element of the core network report cell paging configurations to the logic network element of the core network.

The granularity for the logic network element of the core network to issue a paging configuration may be TA (tracking area). That is, base stations belonging to the same TA area all issue the same cell paging configuration.

The logic network element of the core network may be an MME or an Access and Mobility Management Function (AMF).

If a neighbor cell and the serving cell belong to the same base station, the above steps are not required.

The base station managing the serving cell may send a paging configuration with a granularity of a TA (tracking area) or a Radio Access Network (RAN) area. A paging configuration with a TA granularity is sent by an MME/AMF to the base station managing the UE serving cell through an S1/NG interface. A paging configuration with a RAN area granularity is determined by the base station managing the UE serving cell.

UE may obtain a paging configuration for a neighbor cell by acquiring the paging configuration information, by:

receiving Radio Resource Control (RRC) dedicated signaling or a system message from a base station managing the serving cell; and

extracting the paging configuration information from the system message or the RRC dedicated signaling.

System information of the serving cell, such as multiplexed SIB2, or RRC dedicated signaling, such as an RRC connection release message or an RRC connection establishment message, is received.

Idle-state UE receives system information from the serving cell. Connected-state UE receives system information or RRC dedicated signaling from the serving cell.

The following describes how UE performs measurement based on paging configurations of the serving cell and a neighbor cell.

Measurement may be performed based on paging configuration for a cell/cells, which may be determined in a network-assisted mode or a network-controlled mode.

In the network-assisted mode, paging configuration information of all neighbor cells of the UE are sent. That is, the operation of sending paging configuration information to the UE may include that: paging configuration information of all neighbor cells is sent to the UE. The UE decides which paging configuration or paging configurations on which measurement is based, and how to perform measurement. The processing is performed mainly at the UE side, and is not listed exhaustively here.

In the network-controlled mode, UE may perform idle-state measurement according to a cell paging configuration sent by the base station, specifically in a processing manner as follows.

In a first processing manner, paging configuration information to be used may be sent to the UE according to a power saving need and/or a measurement need sent by the UE.

For example, the following may be included.

A power saving need and/or a measurement need reported by the UE may be acquired.

Paging configuration information to be used by the UE may be determined based on the power saving need and/or the measurement need.

Paging configuration information to be used by the UE may be sent to the UE.

Paging configuration information for all neighbor cells may be sent to the UE.

For example, the base station determines which cell's paging configuration the UE is to use based on a power saving need and/or a measurement need previously reported by the UE. In this case, the UE is to perform measurement on the serving cell and a neighbor cell based on the paging configuration indicated by the base station.

In a second processing manner, paging configuration information for the serving cell and the neighbor cell may be sent to the UE.

For example, the base station has sent a respective paging configuration for each cell. Then, the UE must perform measurement on the serving cell and a neighbor cell based on respective paging configurations corresponding respectively to the serving cell and the neighbor cell.

In a third processing manner, at least one paging configuration may be sent for the neighbor cell and the serving cell of the UE.

In a fourth processing manner, the base station may send paging configuration information for the serving cell; and send at least one piece of paging configuration information for all neighbor cells.

In other words, the base station sends a paging configuration for the serving cell, and sends another paging configuration or other paging configurations for all neighbor cells. Then, the UE has to perform measurement on the serving cell based on the paging configuration for the serving cell, and perform measurement on all neighbor cells based on the one or more paging configurations for the neighbor cells.

In a fifth processing manner, paging configuration information for a cell group corresponding to the serving cell and the neighbor cell may be sent to the UE.

That is, the base station sends a cell group-based paging configuration for the serving cell and neighbor cells. The UE has to perform measurement on a cell based on paging configuration for the cell group including the cell. A cell group may be formed based on a cell frequency or another configuration (such as a paging area, a tracking area).

In a sixth processing manner, first paging configuration information may be sent to the UE for the serving cell. Cell group-based second paging configuration may be sent for the neighbor cell.

There may be multiple pieces of second paging configuration information, and the number is not limited here.

In other words, the base station sends a paging configuration for the serving cell and a cell group-based paging configuration for a neighbor cell. The UE has to perform measurement on the serving cell based on the paging configuration for the serving cell. The UE has to perform measurement on a neighbor cell based on the paging configuration for the cell group to which the neighbor cell belongs.

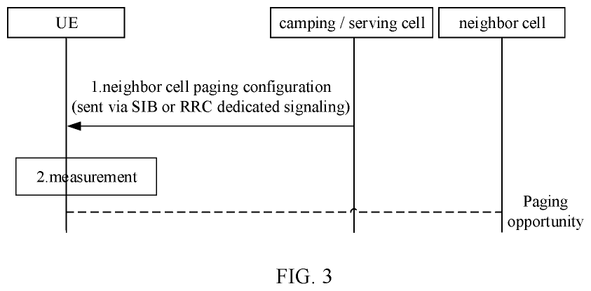

Combining the methods at the UE side and the base station side, the embodiment provides FIG. 3, describing a system processing flow as follows.

UE receives paging configuration for a neighbor cell sent by a base station managing a serving cell.

The UE performs measurement based on the paging configuration.

Specific implementation of the foregoing description is provided as follows.

### Example 1: Network-Assisted Mode

The neighbor cell and the serving cell are managed by the same base station. Therefore, the paging configuration information for the neighbor cell may be directly obtained and sent to the UE without inter-BS negotiation.

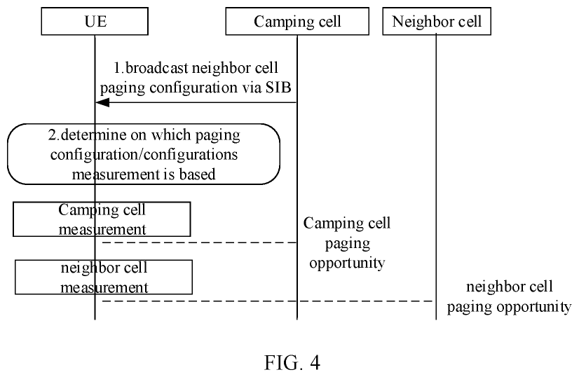

In the embodiment, referring to FIG. 4, the UE obtains paging configurations for the serving cell and all neighbor cells through System Information Block (SIB) of the serving cell. The UE performs measurement on the serving cell based on the paging configuration for the serving cell broadcast by the serving cell. The UE selects one of the paging configurations for the neighbor cells, and performs measurement on all neighbor cells using the selected configuration information.

### Example 2: Network-Controlled Mode

The neighbor cell and the serving cell are managed by the same base station. Therefore, the paging configuration information for the neighbor cell may be directly obtained and sent to the UE without inter-BS negotiation.

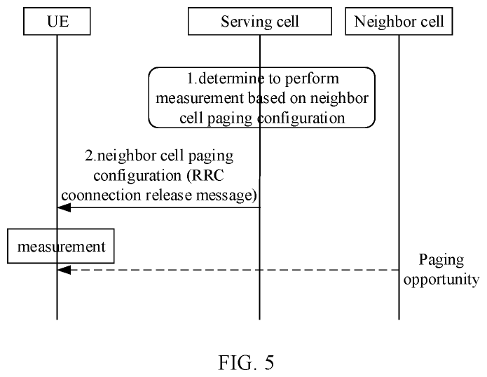

In this embodiment, as illustrated in FIG. 5, the UE is currently in a connected state. After the serving cell decides to release the RRC connection of the UE, the UE needs to perform measurement on the serving cell and the neighbor cell using the paging configuration for the neighbor cell. Therefore, the paging configuration for the neighbor cell may be sent to the UE through the RRC connection release message. Subsequently, the UE is to perform measurement on the serving cell (the serving cell in the connected state) and the neighbor cell using the paging configuration information for the neighbor cell indicated by the serving cell.

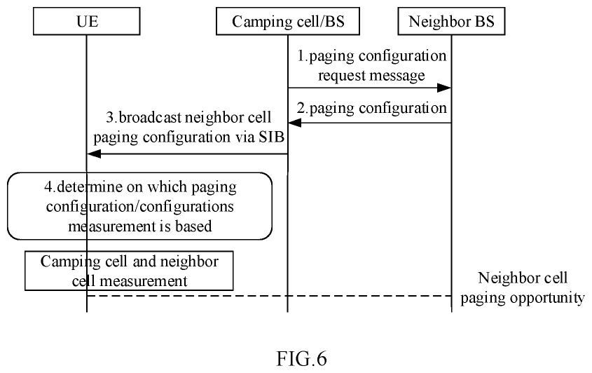

### Example 3: Neighbor Cell Related Configuration is Obtained from a Neighbor Base Station Through an Inter-BS Interface, as Illustrated in FIG. 6

The neighbor cell and the serving cell are managed respectively by different base stations. Therefore, the paging configuration information for the neighbor cell is to be obtained by inter-BS negotiation.

The UE obtains the paging configuration information for the neighbor cell from SIB of the serving cell, and determines a paging configuration on which measurement is to be based. Here, the UE determines to perform measurement on the serving cell and the neighbor cell using the paging configuration for the neighbor cell.

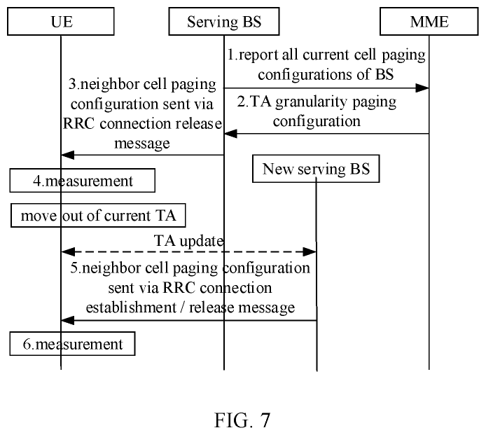

### Example 4: The Paging Configuration of a TA Granularity is Re-Obtained During a Tracking Area Update (TAU) Procedure, as Illustrated in FIG. 7

In this embodiment, the MME sends a paging configuration of a TA granularity to the serving base station serving the UE. The serving base station delivers the TA granular paging configuration to the UE through the RRC connection release message. Based on this paging configuration set, the UE determines the neighbor cell/neighbor cells the paging configurations for which are to be used as basis for idle state measurement. When the UE moves out of the current TA area, the UE initiates a TAU procedure, in which the new serving base station sends the paging configuration set for the new TA to the UE through the RRC connection establishment message or the RRC connection release message. The UE determines, based on the paging configuration set for the new TA area, the neighbor cell/neighbor cells the paging configurations for which are to be used as basis for idle state measurement.

It can be seen that by adopting the above solution, it is possible to perform measurement on the serving cell of the UE or a neighbor cell of the UE according to the paging configuration information issued by the network side, thereby implementing measurement based on the paging cycle of the neighbor cell, instead of the paging cycle of the serving cell according to related art, thereby reducing unnecessary measurement on the neighbor cell, and reducing power consumption of the UE.

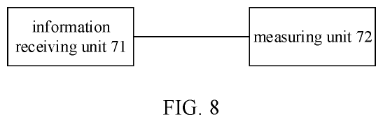

The present disclosure further provides User Equipment (UE), as illustrated in FIG. 8. The UE includes an information receiving unit and a measuring unit.

The information receiving unit 71 is configured for acquiring paging configuration information. The paging configuration information includes at least a paging cycle for a neighbor cell.

The measuring unit 72 is configured for performing measurement on a serving cell and the neighbor cell based on the paging configuration information.

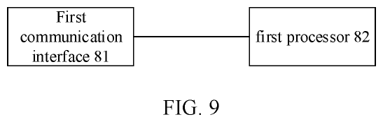

The present disclosure further provides User Equipment (UE), as illustrated in FIG. 9. The UE includes a first communication interface and a first processor.

The first communication interface 81 is configured for acquiring paging configuration information. The paging configuration information includes at least a paging cycle for a neighbor cell.

The first processor 82 is configured for performing measurement on a serving cell and the neighbor cell based on the paging configuration information.

In an embodiment herein, the operation of acquiring paging configuration information may include that: UE acquires paging configuration information for a neighbor cell of the serving cell of the UE. The paging configuration information includes at least a paging cycle, and may also include a paging density nB. Specifically, the paging configuration information may include a paging density for a neighbor cell.

In the case of FDD, the PO may be any of sub-frames 0, 4, 5, and 9.

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

In the case of TDD, the PO may be any of sub-frames 0, 1, 5, and 6.

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

For example,

| | TDD cell 1 (serving cell) | TDD cell 2 (neighbor cell) |
|---|---|---|
| IMSI | 404685505601234 | |
| UE_ID | IMSI mod 1024 = 722 | |
| Tue | 128 | |
| Tc | 32 | 256 |
| T | T = min(Tc, Tue) = 32 | T = min(Tc, Tue) = 128 |
| nB | 4T | T/2 |
| N | N = min(T, nB) = 32 | N = min(T, nB) = 64 |
| Ns | Ns = max(1, nB/T) = 4 | Ns = max(1, nB/T) = 1 |
| i_s | i_s = floor(UE_ID/N) | i_s = floor(UE_ID/N) mod |
| | mod Ns = 2 | Ns = 0 |
| PF | It is computed that PF | SFN mod T = (T div N)*(UE_ID |
| | has to meet: | mod N) is met |
| | SFN mod 32 = 18 | It is computed that PF has to meet: |
| | | SFN mod 128 = 36 |
| PO | By looking up the table | By looking up the table using Ns |
| | using Ns and i_s, the | and i_s, the sub-frame |
| | sub-frame number is 5 | number is 0 |

If a paging message is monitored according to configuration for the serving cell, the UE needs to wake up once every 32 radio frames. However, if a paging message is monitored according to a neighbor cell, the UE only needs to wake up once every 128 radio frames. Power consumption may be lowered by 75%.

In this case, the UE may be made to perform measurement on the TDD cell 2 (neighbor cell) using a default paging cycle and a default paging density, to minimize UE power consumption caused by TDD cell 2 (neighbor cell) measurement. Alternatively, the default paging cycle is maintained, increasing the paging density, etc., properly, to achieve a balance between a measurement performance and a UE power consumption.

A neighbor base station sends paging configuration information for a neighbor cell to the base station managing the serving cell of the UE through an interface between the base stations.

The paging configuration information is paging configuration information received by the base station managing the serving cell from a base station managing the neighbor cell through an interface between the base station managing the serving cell and the base station managing the neighbor cell.

Alternatively, the paging configuration information is paging configuration information for the neighbor cell received by the base station managing the serving cell from a core network through an S1 interface or a Non-Guaranteed (NG) interface between the base station managing the serving cell and the core network.

Before this step, there may be a paging configuration report message. That is, all base stations belonging to a logic network element of the core network report cell paging configurations to the logic network element of the core network.

The granularity for the logic network element of the core network to issue a paging configuration may be TA (tracking area). That is, base stations belonging to the same TA area all issue the same cell paging configuration.

The logic network element of the core network may be an MME or an Access and Mobility Management Function (AMF).

If a neighbor cell and the serving cell belong to the same base station, the above steps are not required.

The base station managing the serving cell may send a paging configuration with a granularity of a TA (tracking area) or a Radio Access Network (RAN) area. A paging configuration with a TA granularity is sent by an MME/AMF to the base station managing the UE serving cell through an S1/NG interface. A paging configuration with a RAN area granularity is determined by the base station managing the UE serving cell.

UE may obtain a paging configuration for a neighbor cell by the first communication interface 81, configured for: receiving Radio Resource Control (RRC) dedicated signaling or a system message of a base station managing the serving cell; and extracting the paging configuration information from the system message or the RRC dedicated signaling.

System information of the serving cell, such as multiplexed SIB2, or RRC dedicated signaling, such as an RRC connection release message or an RRC connection establishment message, is received.

Idle-state UE receives system information from the serving cell. Connected-state UE receives system information or RRC dedicated signaling from the serving cell.

The following describes how UE performs measurement based on paging configurations of the serving cell and a neighbor cell.

Measurement may be performed based on paging configuration for a cell/cells, which may be determined in a network-assisted mode or a network-controlled mode.

The first communication interface 81 is configured for performing measurement on the serving cell and the neighbor cell in a network-assisted mode based on the paging configuration information.

Alternatively, the first communication interface is configured for performing measurement on the serving cell and the neighbor cell in a network-controlled mode based on the paging configuration information.

In the network-assisted mode, paging configuration information of all neighbor cells of the UE are acquired. That is, the UE obtains the paging configuration information of all neighbor cells from the base station. The UE decides which paging configuration or paging configurations on which measurement is based, and how to perform measurement. Specifically, it may be one of the following three processing manners:

In a first processing manner, the first processor 82 selects a paging cycle and/or a paging density in paging configuration information for a target neighbor cell based on a paging cycle and/or a paging density for the serving cell, paging configuration information for all neighbor cells in the paging configuration information, and a power saving need and/or a measurement need of the UE, and performs measurement on the serving cell and the neighbor cell based on the selected paging cycle and/or paging density in the paging configuration information for the target neighbor cell.

UE decides which cell's paging configuration to use based on a power saving need and/or a measurement need of the UE. For example, the UE needs to save as much power as possible. Then, the UE performs measurement on the serving cell and any neighbor cell according to a paging configuration among paging configurations for the serving cell and neighbor cells with the greatest paging cycle. As another example, the UE selects a compromised paging cycle from paging configurations for all cells and performs measurement on the serving cell and neighbor cells based on the compromised paging cycle.

A power saving need may mean that UE has ever reported to the network when it was in a connected state and wanted to modify a DRX cycle to a larger value. Thereby, the network may infer that the UE may need to save power during this period. So, when the UE enters into the idle state, a UE-specific paging cycle, which is larger than the defaultPagingCycle, may be configured for the UE.

A measurement need may mean that UE has ever reported some auxiliary information, such as location information reported by the UE within a period of time. Based on the location information, the network finds that the UE is in a certain area during this period, and it is predicted that the UE will remain in the area for a long time in the future. In a scene, the user stays in an office building all day. In this case, the network deems that the UE does not need to measure so frequently, because the UE hardly triggers any mobility-related operation. Therefore, the network will configure a UE-specific paging cycle larger than the defaultPagingCycle for the UE.

In a second processing manner, the first processor 82 performs measurement on the serving cell based on a paging cycle in paging configuration information for the serving cell. The first processor performs measurement on each neighbor cell of all neighbor cells based on a paging cycle and/or a paging density in paging configuration information for the each neighbor cell.

That is, the UE performs measurement on the serving cell using the paging configuration for the serving cell, and performs measurement on a neighbor cell using the paging configuration for the neighbor cell.

In a third processing manner, the first processor 82 performs measurement on the serving cell based on paging configuration information for the serving cell.

At least one piece of paging configuration information is selected from paging configuration information for all neighbor cells Measurement is performed on a neighbor cell based on a paging cycle and/or a paging density in the at least one piece of paging configuration information as selected.

That is, the UE performs measurement on the serving cell using the paging configuration for the serving cell, and selects one or more paging cycles from the paging configurations of all neighbor cells to measure a neighbor cell.

In the network-controlled mode, UE has to perform idle-state measurement according to a cell paging configuration sent by the base station, specifically in one of the following processing manners.

In a first processing manner, the first processor sends a power saving need and/or a measurement need to a base station via the first communication interface, receives paging configuration information to be used sent by the base station via the first communication interface, and performs measurement on the serving cell and the neighbor cell based on the paging configuration information to be used.

For example, the base station determines which cell's paging configuration the UE is to use based on a power saving need and/or a measurement need previously reported by the UE. In this case, the UE is to perform measurement on the serving cell and a neighbor cell based on the paging configuration indicated by the base station.

In a second processing manner, the first communication interface is configured for acquiring paging configuration information for each cell on which measurement is to be performed from the base station. A cell on which measurement is to be performed includes a serving cell and a neighbor cell.

The first processor is configured for performing measurement on the serving cell and the neighbor cell based on paging configuration information sent by a base station for each cell on which measurement is to be performed.

For example, the base station has sent a respective paging configuration for each cell. Then, the UE must perform measurement on the serving cell and a neighbor cell based on respective paging configurations corresponding respectively to the serving cell and the neighbor cell.

In a third processing manner, the first communication interface is configured for acquiring at least one piece of paging configuration information sent by the base station for the serving cell and the neighbor cell.

The first processor is configured for performing measurement on the serving cell and the neighbor cell based on at least one piece of paging configuration information.

In other words, the base station sends one or more paging configurations for the serving cell and neighbor cells. The UE performs measurement on the serving cell and a neighbor cell based on the one or more paging configurations.

In a fourth processing manner, the first communication interface is configured for acquiring paging configuration information for the serving cell and at least one piece of paging configuration information sent for neighbor cells from the base station.

The first processor is configured for performing measurement on the serving cell based on paging configuration information for the serving cell. The first processor is configured for performing measurement on a neighbor cell based on at least one piece of paging configuration information corresponding to the neighbor cell.

In other words, the base station sends a paging configuration for the serving cell, and sends another paging configuration or other paging configurations for all neighbor cells. Then, the UE has to perform measurement on the serving cell based on the paging configuration for the serving cell, and perform measurement on all neighbor cells based on the one or more paging configurations for the neighbor cells.

In a fifth processing manner, the first processor is configured for, in performing measurement on the serving cell or a neighbor cell, performing measurement on paging configuration information corresponding to a cell group including the serving cell or the neighbor cell based on paging configuration information for the cell group corresponding to the serving cell and the neighbor cell.

That is, the base station sends a cell group-based paging configuration for the serving cell and neighbor cells. The UE has to perform measurement on a cell based on paging configuration for the cell group including the cell. A cell group may be formed based on a cell frequency or another configuration (such as a paging area, a tracking area).

In a sixth processing manner, the first processor is configured for performing measurement on the serving cell based on first paging configuration information for the serving cell. The first processor is configured for performing measurement on a neighbor cell based on second paging configuration corresponding to a cell group including the neighbor cell.

There may be multiple pieces of second paging configuration information, and the number is not limited here.

In other words, the base station sends a paging configuration for the serving cell and a cell group-based paging configuration for a neighbor cell. The UE has to perform measurement on the serving cell based on the paging configuration for the serving cell. The UE has to perform measurement on a neighbor cell based on the paging configuration for the cell group to which the neighbor cell belongs.

Embodiments herein further provide a base station, including an information sending unit configured for: sending paging configuration information to UE. The paging configuration information includes at least a paging cycle for a neighbor cell.

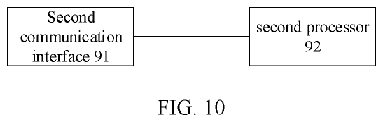

Embodiments herein further provide a base station, as illustrated in FIG. 10, including a second communication interface 91 configured for sending paging configuration information to UE.

The paging configuration information includes at least a paging cycle for a neighbor cell.

In an embodiment herein, the operation of acquiring paging configuration information may include that: acquiring paging configuration information for a neighbor cell of the serving cell of the UE. The paging configuration information includes at least a paging cycle, and may also include a paging density nB.

A neighbor base station sends paging configuration information for a neighbor cell to the base station managing the serving cell of the UE through an interface between the base stations.

A paging configuration request message may also be included. That is, the base station managing the serving cell requests the neighbor base station for a paging configuration for the neighbor cell.

The base station managing the serving cell may select multiple neighbor cells based on a result of measurement by the UE, and send paging configuration request messages to neighbor base stations managing these neighbor cells.

In addition, the base station managing the serving cell may receive paging configuration information for the neighbor cell sent by a core network through an S1 interface or a Non-Guaranteed (NG) interface between the base station managing the serving cell and the core network.

A logic network element of a core network sends paging configuration information for a neighbor cell to the base station managing the serving cell through an S1/NG interface.

Paging configuration information of a base station may further be sent to a core network. That is, all base stations belonging to a logic network element of the core network report cell paging configurations to the logic network element of the core network.

The granularity for the logic network element of the core network to issue a paging configuration may be TA (tracking area). That is, base stations belonging to the same TA area all issue the same cell paging configuration.

The logic network element of the core network may be an MME or an Access and Mobility Management Function (AMF).

If a neighbor cell and the serving cell belong to the same base station, the above steps are not required.

The base station managing the serving cell may send a paging configuration with a granularity of a TA (tracking area) or a Radio Access Network (RAN) area. A paging configuration with a TA granularity is sent by an MME/AMF to the base station managing the UE serving cell through an S1/NG interface. A paging configuration with a RAN area granularity is determined by the base station managing the UE serving cell.

UE may obtain a paging configuration for a neighbor cell by acquiring the paging configuration information, by:

receiving Radio Resource Control (RRC) dedicated signaling or a system message from a base station managing the serving cell; and

extracting the paging configuration information from the system message or the RRC dedicated signaling.

System information of the serving cell, such as multiplexed SIB2, or RRC dedicated signaling, such as an RRC connection release message or an RRC connection establishment message, is received.

Idle-state UE receives system information from the serving cell. Connected-state UE receives system information or RRC dedicated signaling from the serving cell.

The following describes how UE performs measurement based on paging configurations of the serving cell and a neighbor cell.

Measurement may be performed based on paging configuration for a cell/cells, which may be determined in a network-assisted mode or a network-controlled mode.

In the network-assisted mode, paging configuration information of all neighbor cells of the UE are sent. That is, the operation of sending paging configuration information to the UE may include that: sending, to the UE, paging configuration information of all neighbor cells. The UE decides which paging configuration or paging configurations on which measurement is based, and how to perform measurement.

In the network-controlled mode, UE may perform idle-state measurement according to a cell paging configuration sent by the base station, specifically in a processing manner as follows.

In a first processing manner, paging configuration information to be used may be sent to the UE according to a power saving need and/or a measurement need sent by the UE.

For example, the base station determines which cell's paging configuration the UE is to use based on a power saving need and/or a measurement need previously reported by the UE. In this case, the UE is to perform measurement on the serving cell and a neighbor cell based on the paging configuration indicated by the base station.

In a second processing manner, the second communication interface 91 may send paging configuration information for the serving cell and the neighbor cell to the UE.

In a third processing manner, the second communication interface 91 may send at least one paging configuration for the neighbor cell and the serving cell of the UE.

In a fourth processing manner, the second communication interface 91 may send paging configuration information for the serving cell, and send at least one piece of paging configuration information for all neighbor cells.

In other words, the base station sends a paging configuration for the serving cell, and sends another paging configuration or other paging configurations for all neighbor cells. Then, the UE has to perform measurement on the serving cell based on the paging configuration for the serving cell, and perform measurement on all neighbor cells based on the one or more paging configurations for the neighbor cells.

In a fifth processing manner, the second communication interface 91 may send paging configuration information for a cell group corresponding to the serving cell and the neighbor cell to the UE.

That is, the base station sends a cell group-based paging configuration for the serving cell and neighbor cells. The UE has to perform measurement on a cell based on paging configuration for the cell group including the cell. A cell group may be formed based on a cell frequency or another configuration (such as a paging area, a tracking area).

In a sixth processing manner, the second communication interface 91 may send first paging configuration information to the UE for the serving cell, and send cell group-based second paging configuration for the neighbor cell.

There may be multiple pieces of second paging configuration information, and the number is not limited here.

In other words, the base station sends a paging configuration for the serving cell and a cell group-based paging configuration for a neighbor cell. The UE has to perform measurement on the serving cell based on the paging configuration for the serving cell. The UE has to perform measurement on a neighbor cell based on the paging configuration for the cell group to which the neighbor cell belongs.

It can be seen that by adopting the above solution, it is possible to perform measurement on the serving cell of the UE or a neighbor cell of the UE according to the paging configuration information issued by the network side, thereby implementing measurement based on the paging cycle of the neighbor cell, instead of the paging cycle of the serving cell according to related art, thereby reducing unnecessary measurement on the neighbor cell, and reducing power consumption of the UE.

It should be noted that when detecting a GSM network access result, a device for detecting a network access result provided herein is exemplified only with division of the above-mentioned program modules. In actual application, the processing may be allocated to be completed by different program modules as needed. That is, the internal structure of the device is divided into different program modules to complete all or part of the processing described above. In addition, the device for detecting a network access result provided herein belongs to the same concept as embodiments of the method for detecting a network access result. Refer to a method embodiment for specific implementation of the device, which is not repeated here.

Based on hardware implementation of units in the device for detecting a network access result, to implement a method provided herein, embodiments herein further provide a computer storage medium, which is a computer-readable storage medium, such as memory including a computer program. The computer program may be executed by a processor of the device for detecting a network access result to implement steps of the method. The computer-readable storage medium may be magnetic random access memory (FRAM, ferromagnetic random access memory), Read Only Memory (ROM), Programmable Read-Only Memory (PROM), Erasable Programmable Read-Only Memory (EPROM), Electrically Erasable Programmable Read-Only Memory (EEPROM), Flash Memory, Magnetic Surface Memory, an Optical Disk, or Compact Disc Read-Only Memory (CD-ROM), etc.

Solutions according to embodiments herein may be combined with each other as needed as long as no conflict results from the combination.

In embodiments provided herein, it should be understood that the disclosed method and smart equipment may be implemented in other ways. The described equipment embodiments are merely exemplary. For example, the unit division is merely logical function division and can be other division in actual implementation. For example, multiple units or components can be combined, or integrated into another system, or some features/characteristics can be omitted or skipped. Furthermore, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, various functional units in each embodiment of the subject disclosure may be integrated in one second processing unit, or exist as separate units respectively; or two or more such units may be integrated in one unit. The integrated unit may be implemented in form of hardware, or hardware plus software functional unit(s).

What described are but embodiments herein and are not intended to limit the scope of the subject disclosure. Any modification, equivalent replacement, and/or the like made within the technical scope of the subject disclosure, as may occur to a person having ordinary skill in the art, shall be included in the scope of the subject disclosure.

1. A method for cell measurement, implemented by User Equipment (UE), the method comprising:
acquiring paging configuration information, wherein the paging configuration information comprises at least a paging cycle for a neighbor cell; and
performing measurement on a serving cell and the neighbor cell based on the paging configuration information.

2. The method of claim 1, wherein acquiring the paging configuration information comprises:
receiving a system message or Radio Resource Control (RRC) dedicated signaling from a base station managing the serving cell; and
extracting the paging configuration information from the system message or the RRC dedicated signaling.

3. The method of claim 1, wherein granularity of the paging configuration information is a Tracking Area (TA) or a Radio Access Network (RAN) paging area.

4. The method of claim 1, wherein the paging configuration information further comprises:
a paging density for the neighbor cell.

5. The method of claim 1, wherein performing measurement on the serving cell and the neighbor cell based on the paging configuration information comprises one of:
performing measurement on the serving cell and the neighbor cell in a network-assisted mode based on the paging configuration information; or
performing measurement on the serving cell and the neighbor cell in a network-controlled mode based on the paging configuration information.

6. The method of claim 5, wherein performing measurement on the serving cell and the neighbor cell in the network-assisted mode based on the paging configuration information comprises one of:
selecting at least one of a paging cycle or a paging density in paging configuration information for a target neighbor cell based on at least one of a paging cycle or a paging density for the serving cell, paging configuration information for the neighbor cell in the paging configuration information, and at least one of a power saving need or a measurement need of the UE, and performing measurement on the serving cell and the neighbor cell based on the at least one of the paging cycle or the paging density in the paging configuration information for the target neighbor cell;
performing measurement on the serving cell based on at least one of a paging cycle or a paging density in paging configuration information for the serving cell, and performing measurement on each neighbor cell based on at least one of a paging cycle or a paging density in paging configuration information for the each neighbor cell; or
performing measurement on the serving cell based on paging configuration information for the serving cell; selecting at least one piece of paging configuration information from paging configuration information for the neighbor cell, and performing measurement on the neighbor cell based on at least one of a paging cycle or a paging density in the at least one piece of paging configuration information.

7. The method of claim 5, wherein performing measurement on the serving cell and the neighbor cell in the network-controlled mode based on the paging configuration information comprises one of:
sending at least one of a power saving need or a measurement need to a base station, receiving paging configuration information to be used from the base station, and performing measurement on the serving cell and the neighbor cell based on the paging configuration information to be used;
performing measurement on the serving cell and the neighbor cell based on paging configuration information for the serving cell and the neighbor cell sent by a base station;
performing measurement on the serving cell and the neighbor cell based on at least one piece of paging configuration information sent by a base station;
performing measurement on the serving cell based on paging configuration information for the serving cell; and performing measurement on the neighbor cell based on at least one piece of paging configuration information corresponding to the neighbor cell sent by a base station;
performing measurement on the serving cell or the neighbor cell based on paging configuration information for a cell group comprising the serving cell or the neighbor cell; or
performing measurement on the serving cell based on first paging configuration information for the serving cell, and performing measurement on the neighbor cell based on second paging configuration corresponding to a cell group comprising the neighbor cell.

8. The method of claim 2, wherein the paging configuration information is paging configuration information received by the base station managing the serving cell from a base station managing the neighbor cell through an interface between the base station managing the serving cell and the base station managing the neighbor cell; or
wherein the paging configuration information is paging configuration information for the neighbor cell received by the base station managing the serving cell from a core network through an S1 interface or a Non-Guaranteed (NG) interface between the base station managing the serving cell and the core network.

9. A method for cell measurement, implemented by a base station, the method comprising:
sending paging configuration information to User Equipment (UE), wherein the paging configuration information comprises at least a paging cycle for a neighbor cell.

10. The method of claim 9, further comprising: before sending the paging configuration information to the UE,
sending a paging configuration request message to a base station managing the neighbor cell through an interface with the base station managing the neighbor cell, and receiving paging configuration information from the base station managing the neighbor cell through the interface with the base station managing the neighbor cell; or
receiving paging configuration information for the neighbor cell from a core network through an S1 interface or a Non-Guaranteed (NG) interface with the core network.

11. The method of claim 9, further comprising:
sending paging configuration information of the base station to a core network.

12. The method of claim 9, wherein sending the paging configuration information to the UE comprises one of:
sending paging configuration information to be used to the UE according to at least one of a power saving need or a measurement need sent by the UE;
sending paging configuration information for the serving cell and the neighbor cell to the UE;
sending at least one paging configuration for the neighbor cell and the serving cell of the UE;
sending paging configuration information for the serving cell; and sending at least one piece of paging configuration information for all neighbor cells;
sending, to the UE, paging configuration information for a cell group corresponding to the serving cell and the neighbor cell; or
sending first paging configuration information for the serving cell, and sending cell group-based second paging configuration for the neighbor cell.

13. (canceled)

14. User Equipment (UE), comprising:
a first communication interface, configured for acquiring paging configuration information, wherein the paging configuration information comprises at least a paging cycle for a neighbor cell; and
a first processor, configured for performing measurement on a serving cell and the neighbor cell based on the paging configuration information.

15. The UE of claim 14, wherein
the first communication interface receives a system message or Radio Resource Control (RRC) dedicated signaling from a base station managing the serving cell, and
the first processor extracts the paging configuration information from the system message or the RRC dedicated signaling.

16. (canceled)

17. (canceled)

18. The UE of claim 14, wherein the first processor is specifically configured for:
performing measurement on the serving cell and the neighbor cell in a network-assisted mode based on the paging configuration information; or
performing measurement on the serving cell and the neighbor cell in a network-controlled mode based on the paging configuration information.

19. The UE of claim 18, wherein the first processor is specifically configured for performing operations comprising one of:
selecting a paging cycle in paging configuration information for a target neighbor cell based on at least one of a paging cycle or a paging density for the serving cell, paging configuration information for all neighbor cells in the paging configuration information, and at least one of a power saving need or a measurement need of the UE, and performing measurement on the serving cell and the neighbor cell based on the paging cycle in the paging configuration information for the target neighbor cell;
performing measurement on the serving cell based on a paging cycle in paging configuration information for the serving cell, and performing measurement on each neighbor cell in all neighbor cells based on a paging cycle in paging configuration information for the each neighbor cell; or
performing measurement on the serving cell based on paging configuration information for the serving cell; selecting at least one piece of paging configuration information from paging configuration information for all neighbor cells, and performing measurement on the neighbor cell based on a paging cycle in the at least one piece of paging configuration information.

20. The UE of claim 18, wherein the first processor is specifically configured for performing operations comprising one of:
sending at least one of a power saving need or a measurement need to a base station, receiving paging configuration information to be used from the base station, and performing measurement on the serving cell and the neighbor cell based on the paging configuration information to be used;
performing measurement on the serving cell and the neighbor cell based on paging configuration information for the serving cell and the neighbor cell sent by a base station;
performing measurement on the serving cell and the neighbor cell based on at least one piece of paging configuration information sent by a base station;
performing measurement on the serving cell based on paging configuration information for the serving cell; and performing measurement on the neighbor cell based on at least one piece of paging configuration information corresponding to the neighbor cell sent by a base station;
performing measurement on the serving cell or the neighbor cell based on paging configuration information for a cell group comprising the serving cell or the neighbor cell; or
performing measurement on the serving cell based on first paging configuration information for the serving cell, and performing measurement on the neighbor cell based on second paging configuration corresponding to a cell group comprising the neighbor cell.

21. The UE of claim 14, wherein the paging configuration information is paging configuration information received by the base station managing the serving cell from a base station managing the neighbor cell through an interface between the base station managing the serving cell and the base station managing the neighbor cell; or wherein the paging configuration information is paging configuration information for the neighbor cell received by the base station managing the serving cell from a core network through an S1 interface or a Non-Guaranteed (NG) interface between the base station managing the serving cell and the core network.

22. (canceled)

23. A base station, comprising:
a second communication interface, configured for sending paging configuration information to a UE, wherein the paging configuration information comprises at least a paging cycle for a neighbor cell.

24. The base station of claim 23, wherein the second communication interface is specifically configured for:
sending a paging configuration request message to a base station managing the neighbor cell through an interface with the base station managing the neighbor cell, and receiving paging configuration information from the base station managing the neighbor cell through the interface with the base station managing the neighbor cell; or
receiving paging configuration information for the neighbor cell from a core network through an S1 interface or a Non-Guaranteed (NG) interface with the core network.

25.-29. (canceled)
